(19) United States
(12) Patent Application Publication
(10) Pub. No.: US 2020/0050440 A1
(43) Pub. Date: Feb. 13, 2020

(54) APPLICATION UPGRADING THROUGH SHARING DEPENDENCIES

(71) Applicant: Futurewei Technologies, Inc., Plano, TX (US)

(72) Inventors: Ravi Shanker Chuppala, Cupertino, CA (US); Jun Xu, Cupertino, CA (US)

(21) Appl. No.: 16/058,889

(22) Filed: Aug. 8, 2018

(51) Int. Cl. G06F 8/61; G06F 9/445; G06F 11/14; G06F 9/455

(52) U.S. Cl. CPC G06F 8/63; G06F 9/44505; G06F 2009/45562; G06F 9/45558; G06F 2009/45583; G06F 11/1407

(57) ABSTRACT

A computer-implemented method of upgrading an application running in a basic runtime environment (BRE) of a client device is provided. A template directory structure corresponding to a disk image of the running application is generated. A root file system and application dependencies of the running application are mapped to the template directory structure. Revised application code of the running application can be provisioned within an upgraded application container in the template directory structure. The running application is check-pointed to determine state information. Upon deactivation of the running application, the upgraded application container is activated based on the determined state information and using the mapped root file system and application dependencies.

### TECHNICAL FIELD

The present disclosure is related to system migration and upgradation and, in particular, to systems and methods to support application migration or upgrading through using a disk image file system and sharing application dependencies.

### BACKGROUND

Embedded application systems (e.g., applications that are installed, accessed, and maintained by a single vendor) are examples of closed architecture systems. The application upgrade process in a closed architecture system typically involves copying a new monolithic image into memory, changing the pointing image to the new downloaded image, and rebooting the system. More specifically, the application image with all dependent libraries are bundled into a single blob, which is downloaded, and the new application image is started. If the embedded application system changes to an open architecture system, each application can be handled by third party partners and customers. In this regard, previously independent applications within a closed architecture system may need to coexist with respect to resources, privileges, security and execution if an independent application transitions to an open architecture environment.

In an open architecture environment, application upgrading can be a challenging process. For example, migrating (or upgrading) an application running on a host device while maintaining the state, the infrastructure, and the host device operating system platform can be challenging to achieve without changing aspects that are used by other applications within the open architecture. Additionally, communication of a single blob including new (upgraded) application code and dependencies can be time consuming as well as result in inefficient communication bandwidth use. Therefore, there are multiple challenges in terms of state, down time, transparency, privileges, security and isolation, and system resource use in connection with migrating or upgrading applications in an open architecture.

### SUMMARY

Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to one aspect of the present disclosure, there is provided a computer-implemented method of upgrading an application running in a basic runtime environment (BRE) of a client device. The method includes generating, by one or more processors, a template directory structure corresponding to a disk image of the running application. The one or more processors map a root file system and application dependencies of the running application to the template directory structure. The one or more processors provision revised application code of the running application within an upgraded application container in the template directory structure. The one or more processors check-point the running application to determine state information. Upon deactivation of the running application, the one or more processors activate the upgraded application container based on the determined state information and using the mapped root file system and application dependencies.

Optionally, in any of the preceding embodiments, the one or more processors determine a size of the disk image of the running application, and generate a new disk image for the template directory structure with the upgraded application container, the new disk image having the determined size.

Optionally, in any of the preceding embodiments, the root file system and the application dependencies of the running application reside in an operating system of the client device, and are mapped to the disk image of the running application and to the new disk image.

Optionally, in any of the preceding embodiments, the one or more processors change a root file of the running application to the new disk image including the upgraded application container.

Optionally, in any of the preceding embodiments, the one or more processors store the determined state information to persistent storage.

Optionally, in any of the preceding embodiments, the one or more processors restore the state information into the upgraded application container, prior to deactivating the running application.

Optionally, in any of the preceding embodiments, context information associated with the running application is received, where the context information includes device resource assignment for the running application.

Optionally, in any of the preceding embodiments, context information for the upgraded application container is updated based on the device resource assignment for the running application.

Optionally, in any of the preceding embodiments, the device resource assignment includes one or more of the following: memory assignment, central processing unit (CPU) core assignment, and file system assignment.

Optionally, in any of the preceding embodiments, the check-pointing of the state information includes one or more of the following:

determining central processing unit (CPU) state, determining memory address state for one or more memory pages or memory segments accessed by the running application, determining state of one or more input/output (I/O) communication channels accessed by the running application, and determining an operating system state.

Optionally, in any of the preceding embodiments, the application dependencies include one or both of application libraries and application binaries.

Optionally, in any of the preceding embodiments, the one or more processors detect the revised application code of the running application includes revised dependencies.

Optionally, in any of the preceding embodiments, upon detection that the revised application code includes revised dependencies, the revised dependencies are stored within a system directory of the client device.

Optionally, in any of the preceding embodiments, the system directory with the revised dependencies is mapped to the new disk image storing the upgraded application container.

According to one aspect of the present disclosure, there is provided a device including a memory storage with instructions, and one or more processors in communication with the memory storage. The one or more processors execute the instructions to perform operations including generating a template directory structure corresponding to a disk image of a running application. The performed operations further include mapping a root file system and application dependencies of the running application to the template directory structure. The performed operations further include provisioning revised application code of the running application within an upgraded application container in the template directory structure. The performed operations further include check-pointing the running application to determine state information. The performed operations further include, upon deactivating the running application, activating the upgraded application container based on the determined state information and using the mapped root file system and application dependencies.

Optionally, in any of the preceding embodiments, the one or more processors execute the instructions to perform operations further including determining a size of the disk image of the running application, and generating a new disk image for the template directory structure with the upgraded application container, the new disk image having the determined size.

Optionally, in any of the preceding embodiments, wherein the root file system and the application dependencies of the running application reside in an operating system of the device, and are mapped to the disk image of the running application and to the new disk image.

Optionally, in any of the preceding embodiments, wherein the one or more processors execute the instructions to perform operations further include changing, by the one or more processors, a root file of the running application to the new disk image including the upgraded application container.

Optionally, in any of the preceding embodiments, wherein the one or more processors execute the instructions to perform operations further including storing the determined state information to persistent storage, and restoring the state information into the upgraded application container, prior to deactivating the running application.

Optionally, in any of the preceding embodiments, wherein the one or more processors execute the instructions to perform operations further including receiving context information associated with the running application, the context information including device resource assignment for the running application.

Optionally, in any of the preceding embodiments, wherein the one or more processors execute the instructions to perform operations further including updating context information for the upgraded application container based on the device resource assignment for the running application.

Optionally, in any of the preceding embodiments, wherein the device resource assignment includes one or more of the following: memory assignment, central processing unit (CPU) core assignment, and file system assignment.

According to one aspect of the present disclosure, there is provided a non-transitory computer-readable medium storing instructions for upgrading a running application, that when executed by one or more processors, cause the one or more processors to perform operations. The operations include generating a template directory structure corresponding to a disk image of the running application. The operations further include mapping a root file system and application dependencies of the running application to the template directory structure. The operations further include provisioning revised application code of the running application within an upgraded application container in the template directory structure. The operations further include check-pointing the running application to determine state information. The operations further include, upon deactivating the running application, activating the upgraded application container based on the determined state information and using the mapped root file system and application dependencies.

Optionally, in any of the preceding embodiments, the instructions further cause the one or more processors to perform operations including determining a size of the disk image of the running application, and generating a new disk image for the template directory structure with the upgraded application container, the new disk image having the determined size.

Any one of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is an illustration of a network environment suitable for application upgrading or migration in an open architecture, according to some example embodiments.

FIG. 2 is an illustration of a basic runtime environment (BRE) ecosystem operating on a client device, according to some example embodiments.

FIG. 3 is an illustration of another view of a BRE ecosystem using mapped resources, according to some example embodiments.

FIG. 4 is an illustration of a processing flow for upgrading an application running on a client device, according to some example embodiments.

FIG. 5 is a block diagram illustration of a database schema useful in methods for application upgrading, according to some example embodiments.

FIG. 6 is a block diagram illustrating circuitry for clients and servers that implement algorithms and perform methods, according to some example embodiments.

FIG. 7 is a flowchart of a method suitable for application upgrading or migration using common dependencies, according to some example embodiments.

FIG. 8 is a flowchart of a method suitable for application upgrading or migration using common dependencies, according to some example embodiments.

### DETAILED DESCRIPTION

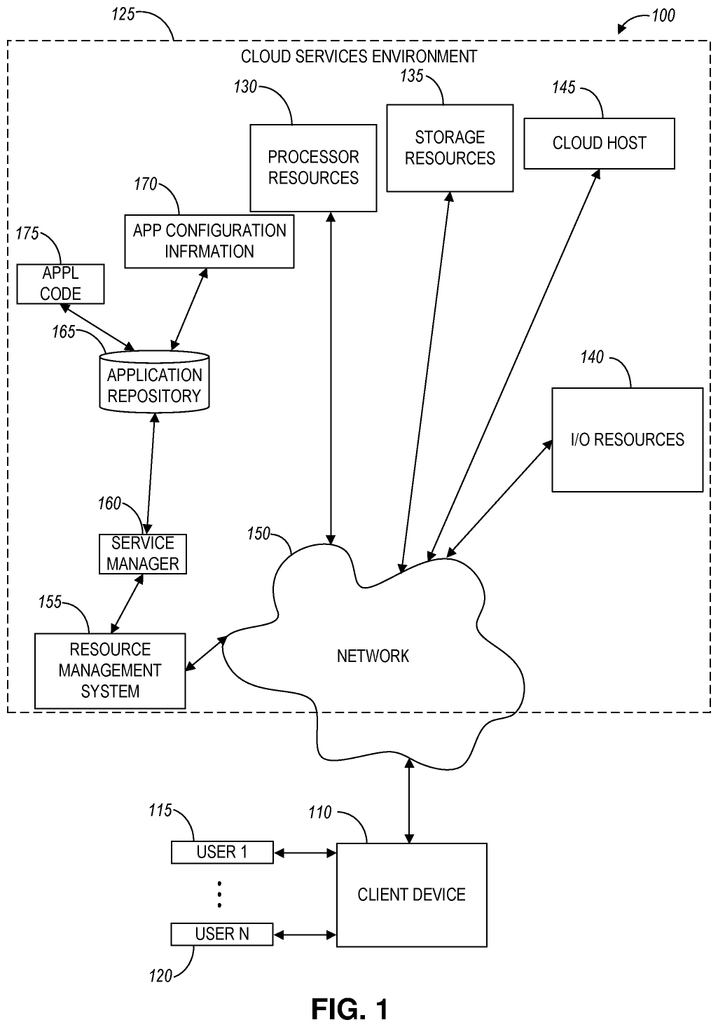

It should be understood at the outset that although an illustrative implementation of one or more embodiments are provided below, the disclosed systems and/or methods described with respect to FIGS. 1-8 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or other type of processor operating on a computer system, such as a switch, server, or other computer system, turning such a computer system into a specifically programmed machine.

As used herein, the term “application migration” indicates the removal of an application installed on a first device and installing the same application for execution on a second device. As used herein, the term “application upgrade” indicates installation of updated application code on a client device, for an application already installed on the same client device. The application upgrade can further include installation of updated application dependencies such as binaries or libraries.

Techniques disclosed herein can be used in connection with upgrading or migrating an application associated with a device operating within an open architecture. This can be accomplished by allocating a disk image with same privileges, security, system resources, and isolation/sharing as a disk image used by a currently running application. The binary dependencies of the application, such as binaries and libraries, can be stored as part of the device file system and can be shared between the application and other processes running on the device. During an application upgrade, the binary application code of the updated application can be transferred to a new disk image (e.g., through a service manager residing on the device or are in a cloud environment) created on the device. The running application state can be check-pointed to obtain various state parameters, the state parameters are transferred to storage, and restored from storage on to the updated application instance within the new disk image. Additionally, the root file system as well as application dependencies that were previously used by the currently running application can be mapped to the new disk image for use by the updated application. Resource sharing, such as CPU resources, memory resources, and file system resources can be set up for the new application based on resource usage by the currently running application. Once the restoration of the application state is completed, the running application can be frozen (e.g., deactivated or deleted) and the updated application can be given execution permission to run.

As used herein, the term “check-pointing” refers to obtaining state information associated with a running application at a given instance in time. As used herein, the term “mapping” (e.g., in connection with a root file system or with other information stored in a file system directory, such as application libraries or binaries) refers to making such directory (or directory structure) available for use by an application process without duplicating/copying the contents of such directory. In some aspects, mapping a given directory can be achieved by executing a “mount” command (e.g., a Linux “/mnt” command in a Linux operating system) so that the directory is “mounted” and accessible for use by an application process. A given directory or other file system content can be stored at one location but can be mapped (e.g., mounted) to multiple applications and used by such applications.

During an application migration, the binary application code of the application can be transferred to a new disk image (e.g., through a service manager residing on the device or are in a cloud environment) created on the device. The root file system and application dependencies associated with the migrated application can be stored as part of the operating system of the device and can be mapped within the new disk image to facilitate sharing of the mapped resources in case of a subsequent application upgrade.

In this regard, migration/upgrade to a new application within an open architecture environment ensures that the new application uses the same process privileges, resource requirements, and security as indicated by the state information of the running application. Additionally, by using mapped root file system and mapped application dependencies already stored on the client device and associated with the previously running application, such information may be omitted from the updated application code when provisioned onto the client device, contributing to more efficient use of communication resources. In comparison, conventional techniques for application upgrade or migration include communication of application code and corresponding dependencies each time the application is upgraded or provisioned for the first time. However, such conventional techniques result in inefficient use of communication bandwidth and system resources since at least the application dependencies from a previous version of the application can be reused by the updated application.

FIG. 1 is an illustration of a network environment 100 suitable for application upgrading or migration in an open architecture, according to some example embodiments. The network environment 100 includes cloud services environment 125 in communication with a client device 110 via a network 150. The cloud services environment 125 includes a resource management system 155, processor resources 130, storage resources 135, and input/output (I/O) resources 140. The resources may be connected to each other via an internal network, via the network 150, or any suitable combination thereof. The processor resources 130 can include computing resources such as central processing units (CPUs) or other computing resources that can be used by clients of the cloud services environment 125. The processor resources 130 may access data from one or more of the storage resources 135, store data in one or more of the storage resources 135, receive data via a network or from input devices, send data via the network or to output devices, or any suitable combination thereof.

The storage resources 135 can include volatile memory, nonvolatile memory, hard disk storage resources, or other types of storage resources. The I/O resources 140 can include suitable circuitry, interfaces, logic, and/or code which can be used to provide communication link between various devices within the network environment 100.

The resource management system 155 can include suitable circuitry, interfaces, logic, and/or code and can be used to manage resources within the cloud services environment 125 and/or resources associated with one or more client devices such as client device 110. In an example embodiment, the resource management system 155 can include a service manager 160. The service manager 160 can include suitable circuitry, interfaces, logic, and/or code and can be configured to perform functions in connection with application migration or application upgrading for applications residing on devices within the cloud services environment 125 as well as client devices (such as client device 110) used by clients of the cloud services environment 125. In this regard, the service manager 160 can be configured to access an application repository 165 within the cloud services environment 125, which can include an application code repository 175 as well as application configuration information repository 170.

In some aspects, the service manager 160 can be a root service running on a device (e.g., an edge device) within the cloud services environment 125 to manage services provided to or by other devices (e.g., within or outside the cloud services environment 125). Example services provided by the service manager 160 can include executing command line tools, building a disk image from an application package or configuration file for a basic runtime environment (BRE), installation and removal of disk images to a device operating system, executing, stopping, or deleting application images, and so forth.

The application code repository 175 can store application code as well as application dependencies (e.g., binaries and libraries) for applications used by customers of the cloud services environment 125. The application configuration information repository 170 can include configuration information associated with one or more applications stored by the application repository 165. The application configuration information stored in repository 170 can include, for example, resource usage requirements such as memory, CPU, and file system requirements for a given application. Additionally, the application configuration information stored in repository 170 can indicate a minimum size of a disk image file that can be used by a given application in connection with application migration or upgrading.

In some aspects, the cloud services environment 125 can include one or more host devices such as cloud host 145, which can perform one or more of the functions of the resource management system 155 and/or any of the additional resources offered by the cloud services environment 125. For example, the cloud host 145 can implement the service manager 160 and can perform one or more of the functionalities described herein in connection with software migration or upgrading.

In some aspects, the application repository 165 can host one or more applications for a customer of the cloud services environment 125. For example, a customer using the client device 110 may provide an application to the cloud services provider for execution on one or more of the processor resources 130.

In other aspects, the client device 110 may be operating in an open architecture environment and it may be accessed by different users, such as users 115, . . . , 120. In this regard, the client device 110 can be configured to execute applications that may be accessed and shared between the users 115, . . . , 120. Application code for such applications running in the open architecture environment can be maintained by the cloud services environment 125 in any updates (or initial installation) of such applications can be provisioned via the service manager 160.

In some aspects, the application code including subsequent updates to the application code and/or application dependencies can be provided as a service by the cloud services environment 125 to facilitate installation of the application and/or application updates to multiple client devices associated with users 115, . . . , 120. In other aspects, the application code including subsequent updates to the application code and/or application dependencies can be provided by one or more of the users 115, . . . , 120 for maintenance at the cloud services environment 125 and to facilitate subsequent access by the client device 110 or any other devices associated with the users 115, . . . , 120.

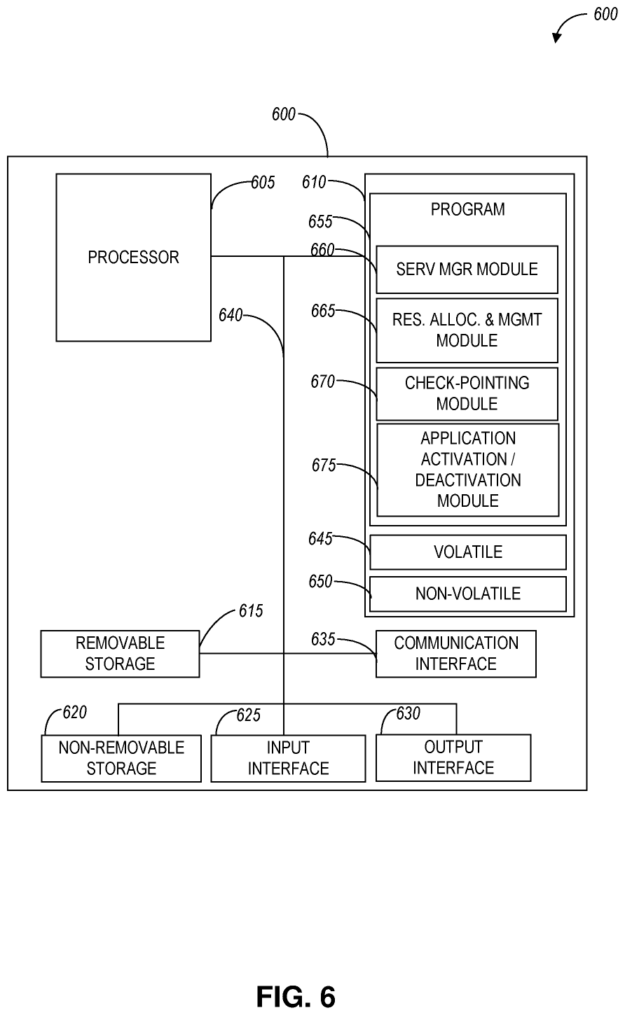

Any one or more of the client device 110, the cloud host 145, the processor resources 130, the storage resources 135, the I/O resources 140, and/or the resource management system 155 may be implemented by a computer system described below in connection with FIG. 6.

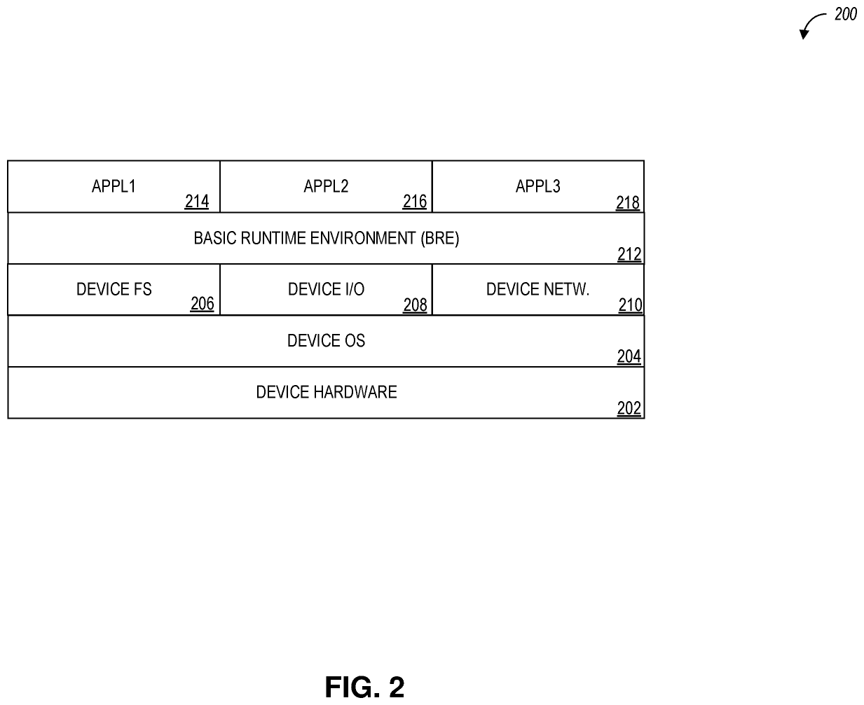

FIG. 2 is an illustration of a basic runtime environment (BRE) ecosystem operating on a client device, according to some example embodiments. As used herein, the term “basic runtime environment” indicates an operating system environment where application code can be executed. Referring to FIG. 2, there is illustrated a device layer stack-up 200 (e.g., for client device 110), which can include device hardware 202, device operating system 204, device file system 206, device I/O 208, device network layer 210, BRE 212, and applications 214, 216, and 218 running on top of the BRE 212.

In some aspects, the BRE 212 is configured to provide an application (e.g., one or more of applications 214-218) with resource sharing, isolation, security and access permission. Once an application is executed, the program (executing the application) is in run-time state. In this state, the application can send instructions to the device CPU and access the device memory and other system resources. In this regard, the BRE 212 can be represented as a collection of software and hardware resources that enables an application to be executed on a system. The system resources can be reserved/limit based on the application type and the application's requirements. The BRE 212 is a composite mechanism designed to provide application services, regardless of the programming language being used for the executed applications.

In some aspects, the BRE 212 can be configured to manage and abstract the hardware, offering the applications an environment in which to execute, with part of the abstraction being used for enforcing the resource ownership. The BRE 212 can be configured to provide common libraries, directory structure, device I/O, and networking. In some aspects, the BRE 212 provides the application with execution isolation and can be configured to share the host files system (e.g., device file system or FS 206), the host's I/O (e.g., device I/O 208), and host's networking (e.g., device networking layer 210). The application isolation is the separation of an application stack from the rest of the running processes. Application isolation can reduce the likelihood of a compromised applications affecting the entire runtime environment.

In some aspects, the BRE 212 can be configured to provide the following services to the application: computing resource partitioning (e.g., limiting access and accounting to memory, limiting access and accounting to CPU, limiting access to network bandwidth, and limiting access to hard disk size), isolation (e.g., proper naming, proper user access, consistent process ID), sharing with a host (e.g., sharing host's file system, sharing host's networking, and sharing host's I/O), limiting execution/access privilege will (e.g., managing security profiles, managing unauthorized access to system resources, managing root capabilities (CAP), and enhancing access privileges to unprivileged), and environment and orchestration tasks (e.g., environment variables, proper initialization, proper exit, and proper removal).

The device hardware 202 can provide the physical resources for the system, upon which the applications 214-218 can be executed and upgraded. The hardware 202 can be CPU-agnostic and can include one or more CPU cores with memory and peripherals.

The BRE 212 can be configured to share the host device root file system (e.g., device FS 206). In some aspects, a separate root file system template can be generated within the BRE environment, and the relevant host root file mount point can be mounted to the BRE 212 to access the file system. Additionally, the host device I/O 208 is also shared and mounted to the BRE file system. The BRE 212 also shares the host device network and peripheral devices, indicated by device networking layer 210. The device FS 206, I/O 208, and networking layer 210 can be shared within applications running within the BRE 212 as well as with other BREs running on the same or different device.

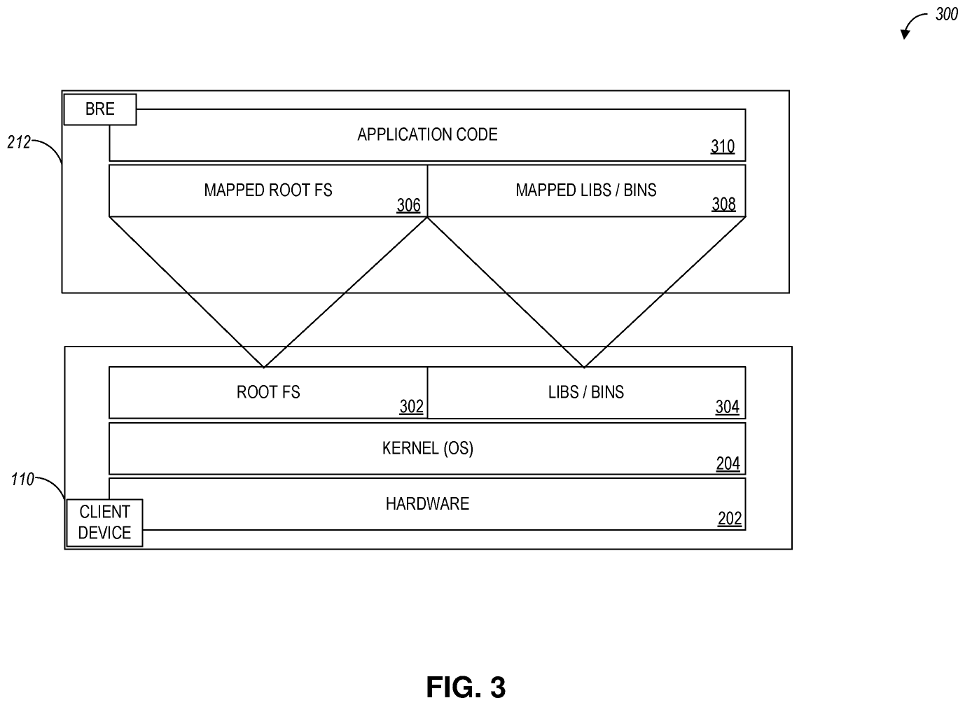

FIG. 3 is an illustration of another view of a BRE ecosystem 300 using mapped resources, according to some example embodiments. Referring to FIG. 3, the BRE ecosystem 300 includes device hardware 202 such as device 110 (or another device such as 145 or 500). The device operating system 204 is represented as a layer on top of the hardware 202. A root file system (root FS) 302 and application dependencies such as libraries and binaries (libs/bins) 304 associated with one or more applications running on the device 110. The BRE 212 can include application code 310 for the one or more applications running on the device 110.

In an example embodiment, the BRE 212 can be configured to use the root FS 302 and the application dependencies 304 residing within the device operating system. More specifically, the root FS and the application dependencies can be mapped as mapped root FS 306 and mapped dependencies 308, which can be accessed by the application code 310 is needed. In this regard, upon installation of an upgraded application code that does not require new dependencies, the root FS and the application dependencies of the previous version of the application code stored in the device operating system can be reused via mapping to the BRE 212.

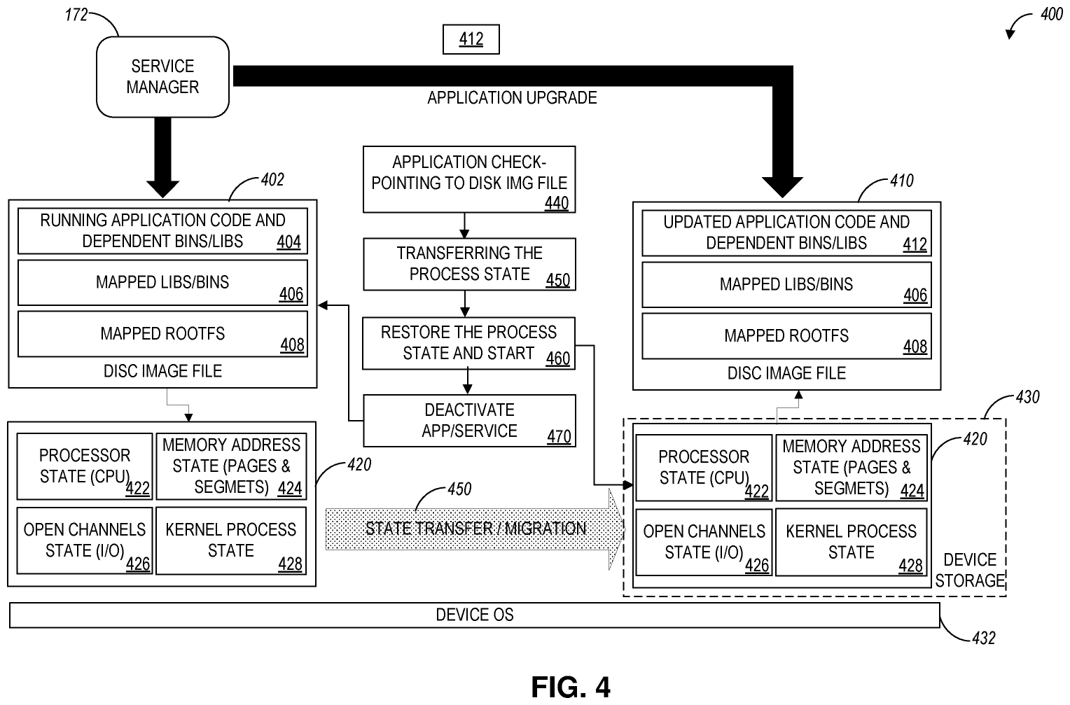

FIG. 4 is an illustration of a processing flow 400 for upgrading an application running on a client device, according to some example embodiments. Referring to FIG. 4, a currently running (first) application can include application code 404 contained within a disk image file 402. The disk image file 402 can further include mapped dependencies 406 (e.g., libraries and binaries) and a mapped root file system 408, with the root FS and the application dependencies residing within the device operating system 432.

In an example embodiment, the following functionalities may be performed for upgrading the currently running application within the disk image file 402. For example, the functionalities recited herein below can be performed by one or more of the following modules illustrated in FIG. 6: the service manager module 660, the resource allocation and management module 665, the check-pointing module 670, and/or the application activation/deactivation module 675.

Initially, disk space is allocated and a raw disk image file 410 is created with a size specified by the service manager 160, where the raw disk image file 410 will be used to house the upgraded application code of the currently running application 404. The service manager 160 obtains the size information of the disk image file 402 from, e.g., the application configuration information repository 170 within the cloud services environment 125. After the raw disk image file 410 is created, the file system structure of the disk image file 402 is replicated within the disk image file 410. For example, same directory and subdirectory names as used within the disk image file 402 are used within the disk image file 410. A template directory structure for a root file system is created within the new disk image file 410. The host device root file system 408 and the application dependencies 406 (used by the running application within the disk image file 402) are mapped within the disk image file 410. In this regard, the disk image file 410 includes the updated application container 412, mapped dependencies (e.g., libraries and binaries) 406, and the mapped root file system 408.

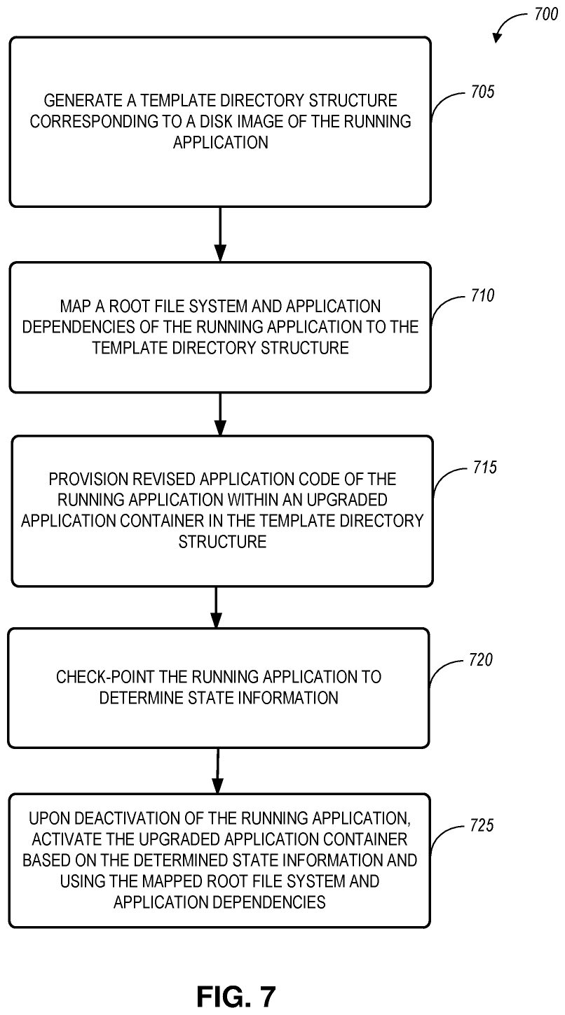

Subsequently, the service manager 160 copies the updated application container 412 (with the updated application code) within the disk image file 410. In aspects where the updated application code requires the use of new application dependencies instead of using the mapped application dependencies 406 of the previous version of the application, new application dependencies are communicated and stored in a new directory associated with the device operating system 432 (e.g., as discussed in connection with FIG. 7). The new application dependencies can then be mapped into the disk image file 410 and can be used in lieu of the previously mapped dependencies 406.

Resource sharing for the updated application container 412 is created based on application context and configuration information for the currently running application. For example, the configuration information obtained from the repository 170 is used to determine memory, CPU, file system, and other device and network resources used by the currently running application, and similar resource assignment can be allocated for use by the updated application.

At operation 440, application check-pointing is performed to the disk image file 402 of the currently running application. More specifically, during application check-pointing, state information 420 associated with the running application is obtained. State information 420 includes CPU state information 422, memory address state information (e.g., associated with memory pages and segments) 424, I/O state information (e.g., information associated with active communication channels) 426, and operating system process state information 428.

At operation 450, the obtained state information 420 is transferred to persistent storage, such as device storage 430. At operation 460, the state information 420 is restored to the updated application container 412, for use when running the updated application. The root of the application can be changed to the new disk image file 410, and the disk image file 410 can be designated as the “rootFS” for the updated application container 412 with the updated application code, and the updated application can be executed. At operation 470, the previous version of the application stored within the disk image file 402 is deactivated/stopped. As used herein in connection with an application, the term “activating” means running an installed application. As used herein in connection with an application, the term “deactivating” means stop stopping an installed application from running or deleting/removing the installed application.

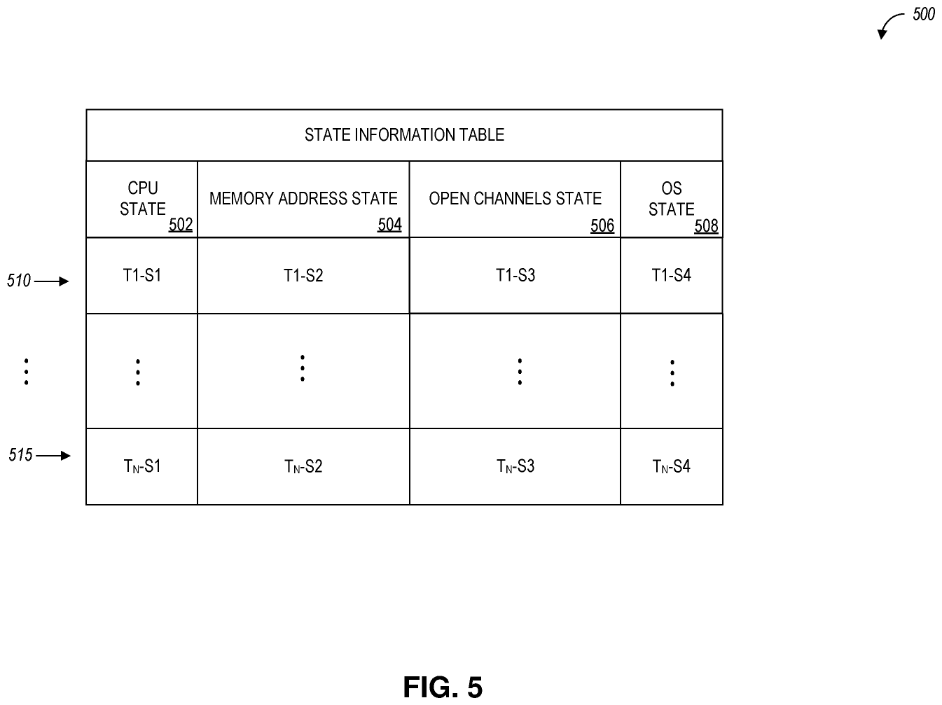

FIG. 5 is a block diagram illustration of a database schema useful in methods for application upgrading, according to some example embodiments. The database schema of FIG. 5 includes state information table 500. The state information 500 includes a CPU state field 502, a memory address state field 504, and open channels state field 506, and an operating system state field 508. Rose 510, . . . , 512 of the state information table 500 are shown. Each of the rows 510, . . . , 515 store state information S1, . . . , S4 obtained for a running application (e.g., by check-pointing the application) at corresponding times T₁, . . . , T_{N}. In some example embodiments, a plurality of state information tables, such as table 500, can be used for a corresponding plurality of running applications.

FIG. 6 is a block diagram illustrating circuitry for implementing algorithms and performing methods, according to example embodiments. All components need not be used in various embodiments. For example, the clients, servers, and cloud-based network resources may each use a different set of components, or in the case of servers for example, larger storage devices.

One example computing device in the form of a computer 600 (also referred to as computing device 600 and computer system 600) may include a processor 605, memory storage 610, removable storage 615, non-removable storage 620, input interface 625, output interface 630, and communication interface 635, all connected by a bus 640. Although the example computing device is illustrated and described as the computer 600, the computing device may be in different forms in different embodiments.

The memory storage 610 may include volatile memory 645 and non-volatile memory 650 and may store a program 655. The computer 600 may include—or have access to a computing environment that includes—a variety of computer-readable media, such as the volatile memory 645, the non-volatile memory 650, the removable storage 615, and the non-removable storage 620. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer-readable instructions stored on a computer-readable medium (e.g., the program 655 stored in the memory 610) are executable by the processor 605 of the computer 600. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example.

The program 655 may utilize a customer preference structure using modules such as a service manager module 660, a resource allocation and management module 665, a check-pointing module 670, and application activation/deactivation module 675. Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The service manager module 660 can perform functionalities similar to the functionalities of the service manager 160 discussed herein. For example, the service manager module 660 can be configured to access application configuration information repository 170 to obtain configuration and context information associated with one or more applications running on the device 600. The service manager module 660 can also be configured to provision/acquire one or more application upgrades, such as the updated application container 412, of applications running on the device 600.

The resource allocation and management module 665 can be configured to perform tasks associated with application upgrading or migration within the device 600. More specifically, the resource allocation and management module 665 can be configured to perform the following functions discussed in connection with FIG. 4: the disk space allocation and raw disk image file generation, generating file system inside the new disk image file, creating template directory structure within the new disk image file, creating resource sharing based on the running application context, and so forth.

The check-pointing module 670 can be configured to perform check-pointing of one or more running applications and generating state information, such as state information 420 in FIG. 4. The check-pointing module 670 can further store the obtained state information to persistent storage, such as device storage 430.

The application activation/deactivation module 675 can be configured to restore state information obtained during check-pointing of a currently running application into the application container of updated application code, activate the new/updated application, and then activate/stop the previously running application.

FIG. 7 is a flowchart of a method 700 suitable for application upgrading or migration using common dependencies, according to some example embodiments. The method 700 includes operations 705, 710, 715, 720, and 725. By way of example and not limitation, the method 700 is described as being performed by the device 600 using the modules 660-675 of FIG. 6.

In operation 705, a template directory structure corresponding to a disk image of the running application is generated. For example, the resource allocation and management module 665 allocates disk space and a raw disk image file 410 is created with a size specified by the service manager module 660, where the raw disk image file 410 will be used to house the upgraded application code of the currently running application 404. The service manager module 660 obtains the size information of the disk image file 402 from, e.g., the application configuration information repository 170 within the cloud services environment 125. After the raw disk image file 410 is created, the resource allocation and management module 665 replicates the file system structure of the disk image file 402 within the disk image file 410. For example, same directory and subdirectory names as used within the disk image file 402 are used within the disk image file 410. The resource allocation and management module 665 then creates a template directory structure for a root file system within the new disk image file 410.

In operation 710, a root file system and application dependencies of the running application is mapped to the template directory structure. For example, the resource allocation and management module 665 performs the mapping (e.g., by executing mounting commands to mount the directories associated with the root file system and the application dependencies), creating the mapped dependencies 406 and the mapped root FS 408 for use by the updated application code.

In operation 715, the revised/updated application code of the running application is provisioned within an upgraded application container in the template directory structure. As used herein, the term “provisioning” in connection with application code indicates that the application code is communicated to the device in response to a request from one or more modules operating on the device, or the one or more modules access a location storing the application code and retrieve such code for use within the device. For example, the service manager module 660 acquires the updated application container 412 including the updated application code (e.g., from the application repository 165).

In operation 720, check-pointing of the running application is performed to determine state information. More specifically, the check-pointing module 670 determines state information 420 associated with the running application. The state information 420 includes, for example, CPU state information 422, memory address state information (e.g., associated with memory pages and segments) 424, I/O state information (e.g., information associated with active communication channels) 426, and operating system process state information 428.

In operation 725, the upgraded application container is activated based on the determined state information and using the mapped root file system and application dependencies. For example, the application activation/deactivation module 675 restores state information obtained during check-pointing of the currently running application into the application container of updated application code, activates the new/updated application, and then deactivates/stops the previously running application.

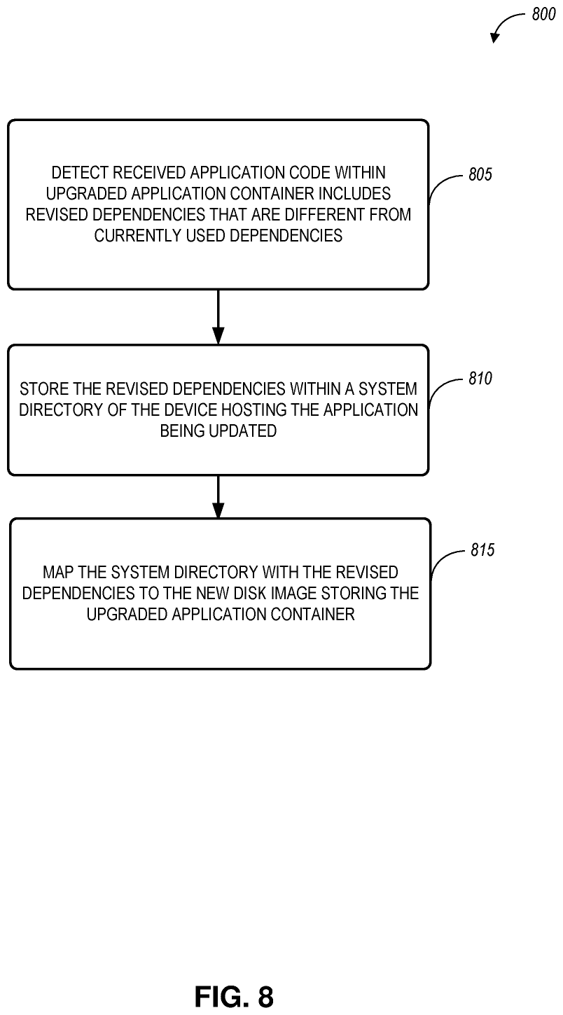

FIG. 8 is a flowchart of a method 800 suitable for application upgrading or migration using common dependencies, according to some example embodiments. The method 800 includes operations 805, 810, and 815. By way of example and not limitation, the method 800 is described as being performed by the device 600 using the modules 660-675 of FIG. 6.

In operation 805, received updated application code is detected to include revised dependencies that are different from the currently used dependencies of a currently running version of the application. For example, the service manager module 660 detects that the updated application container 412 includes updated application code as well as new dependencies (e.g. new binaries and libraries that have not been used by prior versions of the application).

In operation 810, upon detecting the revised application code includes revised dependencies, the revised dependencies are stored within a system directory of the client device. For example, upon detecting the revised application code received with the updated application container 412 includes new dependencies, the service manager module 660 and/or the resource allocation and management module 665 store such dependencies in a new system directory.

In operation 815, the system directory with the revised dependencies are mapped to the new disk image storing the upgraded application container. For example, the service manager module 660 and/or the resource allocation and management module 665 map the new dependencies within the disk image file 410 for use by the updated application code.

Benefits of the systems and methods described herein include, in some example embodiments, direct coverage of the user terminals by the cloud QoS, support for end-to-end absolute QoS, a QoS guarantee for final users, optimized resource management, safety/permission control of access, direct content access, personalized QoS, and preservation of content access. The systems and methods described herein may be applied to multiple types of cloud edge computing scenarios to improve the cloud/edge computing resource allocation, improve cloud providers' benefits, save power and processing cycles, or any suitable combination thereof.

In some example embodiments, compliance with rules defined by a CP data structure (for a virtual machine (VM), resource, network, or any suitable combination thereof) is checked while configuring system parameters. Additionally or alternatively, compliance with rules defined by a CP data structure may be verified by observation (e.g., while configuring system parameters). A system may generate a log for recording all process flows.

Although a few embodiments have been described in detail above, other modifications are possible. Other components may be added to, or removed from, the described systems. Other embodiments may be within the scope of the following claims.

1. A computer-implemented method of upgrading a running application in a basic runtime environment (BRE) of a client device, the method comprising:
generating, by one or more processors, a template directory structure corresponding to a disk image of the running application;
mapping, by the one or more processors, a root file system and application dependencies of the running application to the template directory structure;
provisioning, by the one or more processors, revised application code of the running application within an upgraded application container in the template directory structure;
check-pointing, by the one or more processors, the running application to determine state information; and
activating, by the one or more processors, the upgraded application container with the revised application code based on a deactivation of the running application, the activating using the state information of the running application determined prior to the deactivation, the mapped root file system, and the mapped application dependencies.

2. The method of claim 1, further comprising:
determining, by the one or more processors, a size of the disk image of the running application; and
generating, by the one or more processors, a new disk image for the template directory structure with the upgraded application container, the new disk image having the determined size.

3. The method of claim 2, wherein the root file system and the application dependencies of the running application reside in an operating system of the client device and are mapped to the disk image of the running application and to the new disk image.

4. The method of claim 2, further comprising:
changing, by the one or more processors, a root file of the running application to the new disk image including the upgraded application container.

5. The method of claim 1, further comprising:
storing, by the one or more processors, the determined state information to persistent storage; and
restoring, by the one or more processors, the state information from the persistent storage into the upgraded application container, prior to deactivating the running application.

6. The method of claim 1, further comprising:
receiving context information associated with the running application, the context information including a device resource assignment for the running application; and
updating context information for the upgraded application container based on the device resource assignment for the running application.

7. The method of claim 6, wherein the device resource assignment includes one or more of:
a memory assignment;
a central processing unit (CPU) core assignment; and
a file system assignment.

8. The method of claim 1, wherein the check-pointing of the state information comprises one or more of the following:
determining central processing unit (CPU) state;
determining memory address state for one or more memory pages or memory segments accessed by the running application;
determining state of one or more input/output (I/O) communication channels accessed by the running application; and
determining an operating system state.

9. The method of claim 1, wherein the application dependencies comprise one or both of application libraries and application binaries.

10. The method of claim 2, further comprising:
detecting, by the one or more processors, that the revised application code of the running application includes revised dependencies.

11. The method of claim 10, further comprising:
based on the detecting that the revised application code includes the revised dependencies:
storing the revised dependencies within a system directory of the client device; and
mapping the system directory with the revised dependencies to the new disk image storing the upgraded application container.

12. A device comprising:
a memory storage comprising instructions; and
one or more processors in communication with the memory storage, wherein the one or more processors execute the instructions to perform operations comprising:
generating a template directory structure corresponding to a disk image of a running application;
mapping a root file system and application dependencies of the running application to the template directory structure;
provisioning revised application code of the running application within an upgraded application container in the template directory structure;
check-pointing the running application to determine state information; and
activating the upgraded application container with the revised application code based on a deactivation of the running application, the activating using the state information of the running application determined prior to the deactivation, and using the mapped root file system, and the mapped application dependencies.

13. The device of claim 12, wherein the one or more processors execute the instructions to perform operations further comprising:
determining a size of the disk image of the running application; and
generating a new disk image for the template directory structure with the upgraded application container, the new disk image having the determined size.

14. The device of claim 13, wherein the root file system and the application dependencies of the running application reside in an operating system of the device and are mapped to the disk image of the running application and to the new disk image.

15. The device of claim 13, wherein the one or more processors execute the instructions to perform operations further comprising:
changing, by the one or more processors, a root file of the running application to the new disk image including the upgraded application container.

16. The device of claim 12, wherein the one or more processors execute the instructions to perform operations further comprising:
storing the determined state information to persistent storage; and
restoring the state information into the upgraded application container, prior to deactivating the running application.

17. The device of claim 12, wherein the one or more processors execute the instructions to perform operations further comprising:
receiving context information associated with the running application, the context information including a device resource assignment for the running application; and
updating context information for the upgraded application container based on the device resource assignment for the running application.

18. The device of claim 17, wherein the device resource assignment includes one or more of:
a memory assignment;
a central processing unit (CPU) core assignment; and
a file system assignment.

19. A non-transitory computer-readable medium storing instructions for upgrading a running application, that when executed by one or more processors, cause the one or more processors to perform operations comprising:
generating a template directory structure corresponding to a disk image of the running application;
mapping a root file system and application dependencies of the running application to the template directory structure;
provisioning revised application code of the running application within an upgraded application container in the template directory structure;
check-pointing the running application to determine state information; and
activating the upgraded application container with the revised application code based on a deactivation of the running application, the activating using the state information of the running application determined prior to the deactivation, the mapped root file system, and the mapped application dependencies.

20. The non-transitory computer-readable medium of claim 19, wherein upon execution, the instructions further cause the one or more processors to perform operations comprising:
determining a size of the disk image of the running application; and
generating a new disk image for the template directory structure with the upgraded application container, the new disk image having the determined size.
